(19) United States
(12) Patent Application Publication
(10) Pub. No.: US 2025/0282952 A1
(43) Pub. Date: Sep. 11, 2025

(54) METHOD OF ADDITIVE MANUFACTURING AND DUAL MATERIAL ELASTOMERIC FILAMENT

(71) Applicant: U.S. Army DEVCOM, Army Research Laboratory, Adelphi, MD (US)

(72) Inventors: Jay Hoon Park, Newton, MA (US); Nikhil Avinash Patil, Lowell, MA (US); Eric D. Wetzel, Bel Air, MD (US); Ryan M. Dunn, Boston, MA (US)

(73) Assignee: U.S. Government, as Represented by the Secretary of the Army, Adelphi, MD (US)

(21) Appl. No.: 19/072,806

(22) Filed: Mar. 6, 2025

Related U.S. Application Data
(60) Provisional application No. 63/562,752, filed on Mar. 8, 2024.

(51) Int. Cl. C08L 83/06; B29C 64/118; B29K 55/02; B29K 69/00; B29K 83/00; B33Y 40/10; B33Y 40/20; B33Y 70/00; B33Y 80/00; C08L 55/02; C08L 69/00

(52) U.S. Cl. CPC C08L 83/06; B29C 64/118; B33Y 40/10; B33Y 40/20; B33Y 70/00; B33Y 80/00; C08L 55/02; C08L 69/005; B29K 2055/02; B29K 2069/00; B29K 2083/00

(57) ABSTRACT

We disclose dual filament-based flexible material extrusion which is suitable of additive manufacturing for of at least two thermoplastic elastomers. To enhance printability of a thermoplastic elastomer (TPE), a series of core-shell filaments comprising a TPE shell and a rigid core are fabricated, such as ABS with the ABS volume fraction varying from 11% to 78%, in one particular embodiment. The presence of an ABS core imparts rigidity to the filament to inhibit buckling and allow for successful high-fidelity 3D printing. Rheological characterizations of TPE and ABS using capillary and parallel-plate viscometry point to the optimized extrusion parameters suitable for filament coextrusion, printability, and wettability between the print interfaces. Printed specimens with less than 20% ABS preserve the hardness, providing flexibility and a soft touch to the printed structures. Lower ABS content exhibits higher flexibility and impact resistance, while higher ABS imparts higher stiffness and tensile strength.

### RELATED APPLICATION

This application claims benefit to U.S. Provisional Patent Application No. 63/562,752 filed Mar. 8, 2024, which is incorporated by reference herein its entirety for all purposes.

### STATEMENT REGARDING FEDERALLY SPONSORED RESEARCH OR DEVELOPMENT

This research was financially supported with the HEROES (Harnessing Emerging Research Opportunities to Empower Soldiers) program through a cooperative agreement through DEVCOM Soldier Center (#W911-QY-20-2-0005). The government has certain rights in the invention.

### GOVERNMENT INTEREST

The invention described herein may be manufactured, used and licensed by or for the U.S. Government.

Certain aspects of the invention have been previously disclosed by the inventors in the following:
1) Presentation titled: “ENHANCED STRUCTURAL STABILITY AND MECHANICAL STRENGTH OF THERMOPLASTIC MECHANICAL STRENGTH OF THERMOPLASTIC ELASTOMER BY ADDITIVE MANUFACTURINGELASTOMER BY ADDITIVE MANUFACTURING” presented by Nikhil Patel at APS March Meeting 2023/Mar. 5-10, 2023/Las Vegas, NV; and
2) Journal paper: N. A. Patil, K. Joshi, J. Lee, K. E. Strawhecker, R. Dunn, T. Lawton, E. D. Wetzel, J. H. Park. “Additive Manufacturing of Thermoplastic Elastomer Structures using Dual Material Core-Shell Filaments.” Additive Manufacturing. v82 n104044. 2024 (published online 15 Feb. 2024), which are incorporated by reference herein in their entireties. The latter primarily formed the basis for the '752 provisional application.

### BACKGROUND

3D printing enables the direct production of three-dimensional solids from a digital computer aided design (CAD) file. The most common print method-based on number of trained users, number of printers sold, and volume of material printed—is fused filament fabrication (FFF). In the FFF process, a spool of thermoplastic filament is fed into a print head where the filament is heated and then extruded from a small-diameter nozzle, where it is then deposited onto a build platform (also referred to as a print bed). The print head and bed are part of a computer-controlled motion control system, such as a belt-driven gantry system, so that the extrusion can be deposited systematically into a 3D solid. Typically, the CAD file of the part is provided to a slicing software that programs the motion control system to deposit the thermoplastic in perimeter and fill traces that populate one layer at a time, with each layer built vertically on top of the prior layer. The vertical build direction is referred to as the z-direction.

FFF printers are inexpensive and easy to operate. The spool feedstocks are usually time stable, environmentally benign, and even recyclable. Parts are highly accurate geometrically.

One key challenge of FFF is that the mechanical properties of the parts are limited. Conventional rigid thermoplastics that are commonly FFF printed include ABS, nylon, PLA, and polycarbonate. Parts printed with these materials tend to be mechanically weak, particularly when loaded parallel to the build direction (z-direction). This weakness arises because the thermoplastic of one layer has cooled by the time the next layer is deposited as a hot melted extrudate. The interface between these two materials is only hot and soft for a few seconds, which is not enough time for the processes of wetting and molecular reptation necessary to form a molecularly entangled, high strength interface. As a result, parts loaded in the z-direction fail at low loads, and fail in a brittle manner.

Additionally, these rigid parts tend to have poor cold weather toughness. All polymers are known to go through a ductile to brittle transition as they are cooled, because lower temperatures repress molecular mobilities that are necessary for molecular rearrangements in response to load. Therefore, conventional FFF parts are not generally suitable for use in cold climates, where the parts would be both weak and brittle.

Additionally, there is a need for FFF printing of soft elastomeric materials. Soft materials are useful for medical devices; body-worn devices that need to be comfortable against the skin; gaskets, o-rings, and sealing sleeves; and flexible structures that can be bent, folded, or collapsed. FFF printing introduces filament to the print head by pulling or pushing the filament, typically with traction wheels that grab and advance the filament. The force on the filament can be significant, as this filament force creates the flow pressure that drives melt extrusion from the print head nozzle. If the stiffness of the filament is too low, it will buckle during the feeding process. When the filament buckles, pressure in the print head reduces and extrusion will slow or stop. As a result, the printed part will not be fully formed. In addition, the buckled filament will likely create a jam in the print head that causes a complete print failure. Furthermore, it is known that soft thermoplastics are likely to form fine “strings” in and around the part during printing and can also lead to smearing and slumping of the part. As a consequence, parts printed with soft materials tend to have poor consistency, feature resolution, and surface finish. For this reason, there are few commercial options for soft filaments. A typical “very soft” filament for printing will have a Shore hardness of 85A. This filament can be very difficult to print and requires an experienced user with a well-tuned printer. Softer filaments, such as 75A, are commercially available, but they are known to be extremely difficult to print with quality and consistency. There is a need for a means of printing soft elastomers, such as 75A and 85A, using a conventional printer and ordinary skill. Furthermore, there is a need to a means of printing even softer elastomers with hardness values less than 75A, for example with hardnesses of 65A or 55A.

### SUMMARY

A filament feedstock for 3D printing is described, where the filament includes two materials arranged in a regular geometric arrangement; one of the materials is elastomeric and the other is non-elastomeric. Herein the term “non-elastomeric” material is considered equivalent to “rigid” or “structural” material, meaning a material with sufficient mechanical stiffness and strength to support a reasonable mechanical load without excessive deformation or failure. For example, consider a 200-mm-long bar with a width of 10-mm and a thickness of 2-mm subject to a load of 100 N in tension. If the bar is composed of an elastomeric material, for example with an elastic modulus of 10 MPa, the bar will undergo a strain of 50%, equivalent to lengthening by 100 mm, when loaded. In contrast, if the same bar is composed of a rigid material, for example a rigid polymer with an elastic modulus of 3 GPa, it will lengthen by less than 1 mm under the same load. Generally, a rigid material is intended to carry load without deformation that would lead to dimensional changes that would impede the function of the component, for example a rigid beam or a container or a protective plate. In contrast, elastomers are used in applications where it is desired for the elastomeric solid to deform under light loads, for example as a cushioning application, or to be stretched to provide tension for a retention strap, or as a gasket to fill and seal an uneven gap, or as a flexible plate to contour to another surface.

This filament provides a number of advantages over filaments composed of one material, or composed of two materials where neither is elastomeric. Compared to fully elastomeric filaments, the presence of a more rigid core stabilizes the filament during handling, feeding, and printing, allowing for consistent printing of very soft elastomers that would otherwise not be printable.

Additionally, we disclose dual filament material combinations that enable mechanical resilience at low temperatures. In one strategy, the filament comprises an elastomer and a rigid material. The elastomer has a low glass transition temperature, which allows it to remain tough to low temperatures. The presence of the rigid material in the filament adds stiffness to the filament and to the printed part. The combination of the elastomeric and rigid materials results in printed parts with a balance of high stiffness and cold weather durability which could not be achieved in a part composed of a single material.

Additionally, we disclose filament material combinations that do not include an elastomer, but include two or more thermoplastics that are designed to have cold weather durability, while also being amenable to annealing in order to build part strength while maintaining part geometry. In various embodiments, a first polymer may provide an inner core, and a second polymer may provide an outer sheath or covering

We further disclose many material combinations that provide unique durability properties, such as hardness and elastic modulus, for the dual filaments. In some various embodiments, at least one of the polymers exhibits a glass transition temperature below 25° C. and has a hardness less than or equal to Shore 85D, and more preferably less than or equal to Shore 50A. For example, embodiments provide dual material elastomeric filaments in which: (a) the second polymer has a hardness less than or equal to Shore 85D, and the first polymer may has a hardness greater than Shore 85D; (b) the second polymer has a hardness less than or equal to Shore 95A, and the first polymer has a hardness greater than or equal to Shore 50D; (c) the second polymer has a hardness less than or equal to Shore 85A, and the first polymer has a hardness greater than or equal to Shore 50D; (d) the second polymer has a hardness less than or equal to Shore 75A, and the first polymer has a hardness greater than or equal to Shore 50D; (e) the second polymer has a hardness less than or equal to Shore 65A, and the first polymer has a hardness greater than or equal to Shore 50D; (f) the second polymer has a hardness less than or equal to Shore 55A, and the first polymer has a hardness greater than or equal to Shore 50D; (g) the second polymer has a hardness less than or equal to Shore 45A, and the first polymer has a hardness greater than or equal to Shore 50D; (h) the second polymer has a hardness less or equal to Shore 50D, and the first polymer has a hardness greater than or equal to Shore 70D; (i) the second polymer has a hardness less than or equal to Shore 75A, and the first polymer has a hardness greater than or equal to Shore 50D; or (j) the second polymer has a hardness less than or equal to Shore 50D, and the first polymer has a hardness greater than or equal to Shore 55D. Thus, there are a variety of different combinations of properties for a dual filament, i.e. comprised of a “hard elastomer” first polymer and a “soft elastomer” second polymer. In some instances, the “hard elastomer” first polymer forms an inner core, and the “soft elastomer” second polymer forms an outer cladding (wholly or partially around the inner core).

Moreover, embodiments provide dual material elastomeric filaments in which: (a) the elastic modulus of at least one of the polymers is below 200 MPa; (b) the elastic modulus of the second polymer is below 200 MPa; (c) the elastic modulus of the second polymer is below 200 MPa and the elastic modulus of the first polymer is above 500 MPa; (d) the elastic modulus of the second polymer is below 100 MPa and the elastic modulus of the first polymer is above 500 MPa; (e) the elastic modulus of the second polymer is below 200 MPa and the elastic modulus of the first polymer is above 1000 MPa; or (f) the elastic modulus of the second polymer is below 100 MPa and the elastic modulus of the first polymer is above 1000 MPa. We note that, as discussed herein, the elastic modulus can generally be correlated to hardness value and for an elastomeric polymer. Thus, there may be some overlap in the aforementioned hardness and elastic modulus embodiments.

These and other embodiments of the invention are described in more detail, below.

### BRIEF DESCRIPTION OF THE DRAWINGS

FIG. 1 shows Shore A and Shore D hardness values for various silicone and urethane elastomers and corresponding Modulus values.

FIG. 2 shows high shear viscosity of ABS and TPE in shear rate range of 300 s⁻¹ to 7000 s⁻¹;

FIG. 3A shows low shear viscosity for ABS and TPE from 0.062 rad/s to 628 rad/s and the storage and loss modulus;

FIG. 3B shows low shear viscosity for ABS and TPE from 0.062 rad/s to 628 rad/s and complex viscosities plotted against the angular frequency.

FIG. 4 shows cross sectional images of filaments using optical microscope, where the darker core region is ABS, while the brighter region is the TPE shell, and where the area % of ABS identified in the subtitle.

FIG. 5 shows geometry specimens using 100% ABS, 50% ABS+50% TPE, and 11% ABS+89% TPE filament.

FIG. 6 shows representative images from AFM modulus mapping (A) TPE, (B) ABS, (C) ABS+TPE filament, (D) ABS+TPE printed structure, where the inset circle shows the interface of core and shell. (Light to dark-(A) 0 to 400 MPa, (B)-(D) 0 to 8 GPa).

FIG. 7 Representative cryo-fractured cross-section surface for low infill density (85%, top row) and high infill density (95%, bottom row) printed with ABS+TPE filaments.

FIG. 8 shows charts of key mechanical properties of printed parts with respect to the ABS content, where A) shows shore A hardness values, B) shows flexural modulus characterized by 3-point bending, and linear rule-of-mixtures model, C) shows Izod impact strength, D) shows representative stress-strain curves for z-direction printed tensile bars (high infill density), E) shows Z-direction tensile modulus and inverse rule-of-mixtures model, and F) shows tensile toughness and tensile strength as a function of % ABS for high infill density specimens.

FIG. 9 shows A) Fracture surfaces of Izod testing specimens at 100% ABS, and ABS+TPE (62% ABS and 14% ABS), B) Photographs captured during Izod impact test of high fill fraction specimens, where inset circles indicate the crack site and high ABS % (62%) undergoes brittle failure, whereas low ABS % (14%) undergoes plastic failure with fibrillation.

FIG. 10 shows A) Printed coil springs before testing, B) springs after tensile testing (end of test results) at an ABS extension of 140 mm and an ABS+TPE extension of 155 mm, C) representative load vs extension curves for cyclic dynamic fatigue testing of ABS and ABS+TPE springs, and D) permanent deformation in springs as a function of cyclic extension.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc. Certain inventive features are further provided through tables including design and analysis details as supported by the written description.

### DETAILED DESCRIPTION

Herein we use the term “elastomer” to generally refer to elastomeric polymers that can be softened with heat so they are malleable or readily formable to shape, and then resolidified to retain said shape, also referred to as “elastomeric thermoplastics.” There are many types of elastomeric thermoplastics commercially available or under development, and include but are not limited to: thermoplastic elastomers (TPEs), thermoplastic urethanes (TPUs), and thermoplastic vulcanizates (TPVs).

An elastomer typically has one or more distinguishing features. First, an elastomer generally refers to a polymer that is soft and elastic at room temperature. That is, it can be bent, stretched, twisted, or compressed to significant degrees of deformation, while also recovering back to its initial shape after removal of the imposed deformation. Deformation can be characterized in part via recoverable strain; elastomer will have recoverable strains of 10%, 25%, 50%, 100%, 200%, 400%, or more. In a dual filament arrangement, according to non-limiting embodiments herein, the rigid or first polymer could have a recoverable elongation less than 50% and the soft or second polymer could have a recoverable elongation greater than 100%. We note that a non-elastomer or rigid polymer, such as nylon or polycarbonate, will typically exhibit a recoverable strain of 10% or less. The property of recoverable strain is reasonably equivalent to “elongation at yield” or “strain at yield” for rigid polymers, i.e. the first strain value at which measureable un-recoverable strain is observed. For elastomers, it is possible for their recoverable strain to be more similar to their “elongation at break”, i.e. they can be stretched nearly to failure and still recover most of their elongation.

An elastomer can be characterized in terms of hardness. Although there is no rigorous definition, to those skilled in the art of polymers it is known that polymers with a hardness value on the Shore A scale of 100A or below are generally considered to be elastomers. An elastomer with a hardness of 95A would feel like a vehicle tire; a hardness of 80A would feel like a rubber o-ring; a hardness of 50A would feel like a pencil eraser; and a hardness of 30A would feel like a rubber band. Harder materials could be evaluated on a Shore D scale, with a rigid polymer generally exhibiting a hardness on a Shore D scale of 70D and above.

The Shore A and Shore D scales have some overlap, for example a material with a Shore A hardness of 95A is likely to exhibit a Shore D hardness near 50D. Materials with hardness values between 50D-70D can be considered elastomers, or they can be considered rigid; they are sometimes referred to generically as “hard rubbers”, even if the material is an elastomeric thermoplastic. These materials typically have a low elongation (e.g. less than 20%) and can also act as a structural material for some applications. Therefore, in some circumstances and applications, materials of 50D hardness and higher can be considered “rigid” as the term is used herein.

Elastomers are also known to have very low elastic modulus. Herein, we use the term “modulus” to refer to is a mechanical property of solid materials that measures the stiffness when the force is applied. It is defined as the ratio of the stress (force per unit area) applied to the object and the resulting axial strain (displacement or deformation). Of primarily concerns to us is “elastic modulus,” which commonly refers to the portion of the modulus in which elastic, reversible/recoverable, deformation occurs (as opposed to plastic or permanent deformation). This is characterized the slope of the linear part of the stress-strain curve for a material under tension or compression, also referred to as Young's modulus. The modulus (and elastic modulus, in particular) may be measured via different methods-such as tensile modulus, compressive moudulus, or flexural modulus, or bending modulus testing—as any of these modulus values might be characterized for an elastomer and would give similar modulus magnitudes. Since elastomers are primarily characterized by their overwhelmingly elastic deformation, we use the terms modulus and elastic modulus somewhat interchangeably herein.

Elastic modulus is known to correlate with Shore hardness values for elastomeric materials, for example see, Gent, Alan N. “On the relation between indentation hardness and Young's modulus.” Rubber Chemistry and Technology 31.4 (1958): 896-906; Qi, H. J., K. Joyce, and M. C. Boyce. “Durometer hardness and the stress-strain behavior of elastomeric materials.” Rubber chemistry and technology 76.2 (2003): 419-435; Spahn, Gunter, et al. “Mechanical behavior of intact and low-grade degenerated cartilage/Mechanische Eigenschaften von intaktem und niedriggradig geschädigtem Knorpel.” (2007): 216-222; Meththananda, Iranthi M., et al. “The relationship between Shore hardness of elastomeric dental materials and Young's modulus.” Dental materials 25.8 (2009): 956-959; and Ucar, Hakan, and Ipek Basdogan. “Dynamic characterization and modeling of rubber shock absorbers: A comprehensive case study.” Journal of Low Frequency Noise, Vibration and Active Control 37.3 (2018): 509-518, herein incorporated by reference in their entireties.

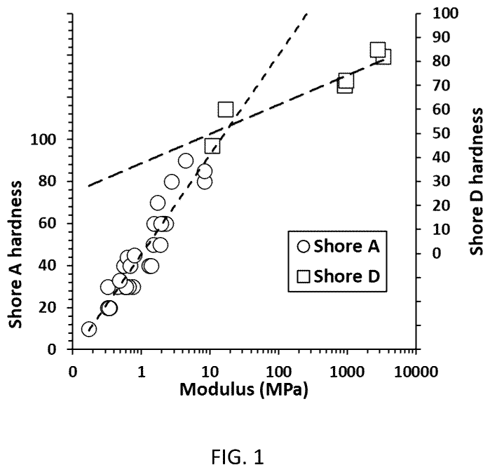

In FIG. 1, Shore A and Shore D hardness values for various silicone and urethane elastomers are plotted. The data values were from extracted from various technical data sheets from Smooth-On Inc., Macungie, PA for its elastomer-grade silicone products (see Dragon Skin, Mold Max, Mold Star, and Smooth SIL) and elastomer-grade urethane products (see PMC and Smooth Cast) and compiled to produce the plot; the data sheets are publicly available at https://www.smooth-on.com/documents/. (We note that similar plots for other elastomers can be generated in this manner.). It can be seen that the elastic modulus for elastomers is typically less than 200 MPa and more commonly less than 100 MPa. In contrast, rigid polymers have modulus values that are considerably higher, at least 500 MPa but in most cases these rigid polymers have a modulus of 1000 MPa (1 GPa) or greater. The “Elastomers” and “Rigid polymers” arrows are not meant to be limiting for all embodiments.

An elastomer also generally exhibits at least one sub-ambient (<25° C.) glass transition temperature, e.g., T_{g} of −60° C. to −5° C. for elastomeric thermoplastics. While all polymers exhibit a “rubbery” behavior below T_{g}, the T_{g} of a non-elastomeric polymer is typically well above room temperature (>25° C.), thus in a relatively rigid “glassy” state at room temperature. In contrast, elastomers generally exhibit a “rubbery” state at room temperature, although they may also have elastomeric properties at colder and warmer temperatures as well. Elastomers can have multiple material temperature transitions, including multiple glass transitions; but at least one glass transition will be exhibited below room temperature. Also, some non-elastomers can have a T_{g} below 25° C. For example a semi-crystalline polymer can have a T_{g} below 25° C. but a melting point that is above 25° C.; if the crystalline content is sufficiently high, this semi-crystalline material would be rigid rather than elastomeric up to the melting point due to the presence of “physical crosslinks” between molecular chains due to the formation of polymer crystals. Some elastomeric thermoplastics are semi-crystalline, for example a block co-polymer that associates into rubbery domains and glassy, crystalline domains. For these semi-crystalline elastomeric thermoplastics, the crystalline domains act as physical crosslinks; but, their size, spacing, and population are small enough so that the mechanical response is dominated by the rubbery phase, leading to low modulus, low hardness, and high elongation.

Table 1 summarizes typical mechanical properties for elastomeric thermoplastics, and rigid thermoplastics.

TABLE 1
Typical thermoplastic mechanical properties. PEI refers to polyether imide.

| | | | | Elongation | Elongation | Tensile | Flex |
|---|---|---|---|---|---|---|---|
| | | Tg | | at yield | at break | modulus | modulus |
| | Polymer | (° C.) | Hardness | (%) | (%) | (MPa) | (MPa) |
| Elastomeric | TPV | (−40)-(−15) | 50-80A | 55 | 300-700 | 4-30 | 14-24 |
| thermoplastics | TPU | (−24)-(−10) | 20-95A | 18-55 | 295-580 | 12-26 | 2-40 |
| Rigid | ABS | 90-105 | 70-80D | 1-6 | 10-50 | 1500-3500 | 1500-2500 |
| thermoplastics | PC-PBT | n/a | 70-80D | 4-5 | 4-150 | 1800-2300 | 1600-3900 |
| | PC | 150-200 | 80-90D | 6-7 | 50-120 | 2200-2500 | 2200-2500 |
| | Nylon (6, 6) | 55-58 | 80-95D | 3-30 | 150-300 | 1000-3500 | 800-3000 |
| | PEI | 190-215 | 95-99D | 6.8-7.2 | 59-60 | 3000 | 3400 |

In one form of the present invention, dual material filaments for 3D printing are claimed for the case where one of the materials in the filament is an elastomer and the other is not an elastomer. The non-elastomer material will be referred to as a rigid material or “first polymer.” The elastomer material will be referred to as a soft material or “second polymer.” The rigid material can be one of the many structural thermoplastics that are currently 3D printed, or are suitable for printing processing. Such printing processing may including thermal draw, dual material extrusion, and/or wire coating.

The filament diameter, as produced, is preferably larger than 1 mm; and the diameter is preferably smaller than 10 mm, and is more preferably smaller than 5 mm. This range of preferred diameters is necessary for successful 3D printing for multiple reasons, including: they are within the acceptable range of filament diameters that can be accepted through the throats and aperatures of typical commercial 3D printers; they are sufficiently large in diameter so that the hobbed gears that are used to feed the filament make sufficient contact with the filament to create traction and flow pressure; and they are sufficiently large in diameter so that the filament has enough bending stiffness to be pushed forward into the heated zone to create pressure on the polymer melt to force extrusion through the nozzle. Typical commercial filaments for 3D printing have a diameter of 1.75, 1.85, or 2.35 mm, although some variants may have slightly larger or smaller diameters.

The first polymer can comprise one or more thermoplastic materials, wholly or as a blended polymer or copolymer including fine-scaled (sub micron) polymer mixtures. For example, the first polymer may be selected from the group consisting of: acrylonitrilebutadienestyrene (ABS); high density polyethylene (HDPE); low density polyethylene (LDPE); polyamide (PA); polyamide imide (PAI); polyarylate (PAR); polyaryletherketone (PAEK); polybutylene terephthalate (PBT); polycarbonate (PC); polyester; polyether sulfone (PES); polyetherketoneketone (PEKK); polyetheretherketone (PEEK); polyetherimide (PEI); polyetherketone (PEK); polyetherketonetherketoneketone (PEKEKK); polyethlyene (PE); polyethylene terephthalate (PET); polyimide (PI); polylactic acid (PLA); polymethyl methacrylate (PMMA); polyoxymethylene (POM); polyphenylene oxide (PPO); polyphenylene sulfide (PPS); polyphenylsulfone (PPSU); polyphthalamide (PPA); polyphthalate carbonate (PPC); polyproplyene (PP); polystyrene (PS); polysulfone (PSF); polyurethane (PU); polyvinyl chloride (PVC); polyvinylidene fluoride (PVDF); styrene acrylonitrile (SAN); styrene maleic anhydride (SMA); ultrahigh molecular weight polyethylene (UHMWPE); high impact polystyrene (HIPS); polyvinyl alcohol (PVA); polyethylene glycol-modified terephthalate (PETG); polytetrafluoroethylene (PTFE), acrylonitrile styrene acrylate (ASA), Nylon and combinations thereof. In some embodiment, the first polymer is a PC copolymer of bisphenol TMC (BPTMC or 1,1-bis(4-hydroxyphenyl)-3,3,5-trimethylcyclohexane) and bisphenol-A (BPA).

The second polymer may be a thermoplastic elastomer, urethane, silicone, a thermoplastic rubber, or a thermoplastic urethane as a few non-limiting examples. In the case of a thermoplastic elastomer, the second may be a styrenic block copolymer, thermoplastic polyolefinelastomer, thermoplastic vulcanizate, thermoplastic polyurethane, thermoplastic copolyester, thermoplastic polyamide, or unclassified thermoplastic elastomer, for instance.

The rigid polymer would be chosen to have compatible processing (both filament formation and printing) with the elastomer. Most thermoplastic elastomers print at relatively modest temperatures, for example 160-240° C., so they would best be paired with rigid polymers that can also be printed at comparable temperatures.

In a further embodiment, the elastomer covers at least half of the outer surface of the filament. That is, the filament generally comprises a core of a first (rigid) polymer, with a sheath of a second elastomeric polymer. For example, at least 50% of the outer surface is comprised of the second thermoplastic polymer. This arrangement provides a number of advantages.

First, the elastomer sheath will be placed into contact with the elastomer sheath of other extrudates that have been deposited on the printed solid. Thermoplastic elastomers are known to have high self-adhesion, so the bonds between deposited traces and even layers are likely to be very resilience.

Second, an elastomeric sheath results in a 3D printed structure in which the elastomer phase is continuous throughout the solid. Therefore, the solid body will “feel” soft and exhibit elastomeric properties; in contrast, if the rigid phase is continuous through the solid body, then the printed body would feel rigid.

Third, the rigid core could be selected to have a flow temperature (glass transition, melt temperature, Vicat softening temperature, heat deflection temperature, or any other relevant thermomechanical transition) suitably high so that the printed dual material body can be subjected to a post-annealing process below the flow temperature of the rigid core polymer. In this process, the rigid core polymer would maintain the geometry of the solid part during the annealing process, while the elastomer would be given time for wetting and reptation to form a high strength bond between traces and layers. For example, the flow temperature of the rigid core polymer could be between 40-400° C., or between 80-300° C., or between 80-250° C. In the aforementioned post-annealing process, it is advantageous for the flow temperature of the elastomer polymer to be lower than the flow temperature of the rigid core polymer, so that the elastomer can undergo wetting and annealing. For example, the flow temperature of the elastomer (second) polymer could be 10, 20, or 50 degrees Celsius lower than the flow temperature of the rigid (first) polymer.

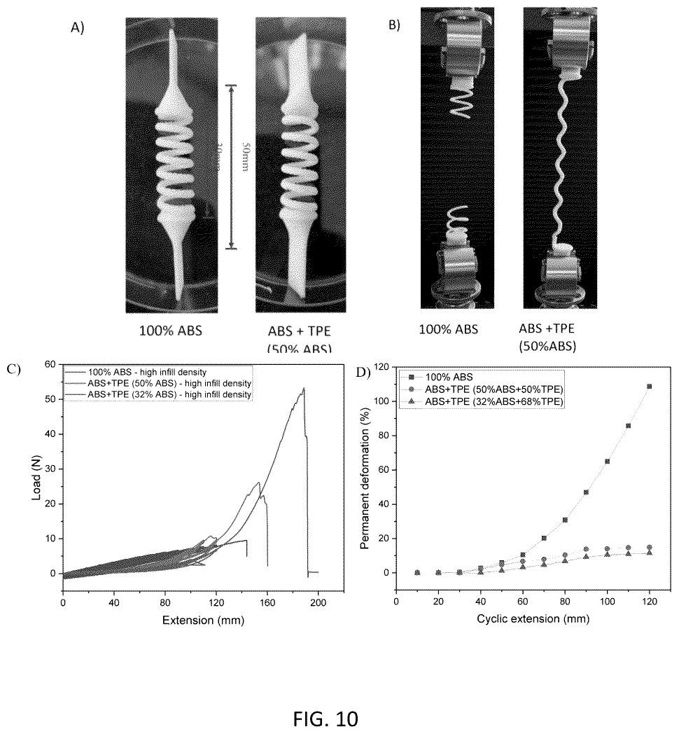

The rigid core of the filament could have a number of shapes including round, square, angular, star-shaped, flat, ring-like, or could include a number of separate rigid cores to provide a multitude of reinforcing elements. The star-shaped core, in particular, has advantages for stabilizing the filament during printing and thermal annealing; while allowing a high volume fraction of elastomer to create a soft 3D solid. For example, the dual filament may include a star-shaped rigid core of one polymer (e.g., the first polymer) having a plurality of arm surrounded by another polymer (e.g., the second polymer, where the arms do not reach the outside of the filament as shown in U.S. Patent Application Publication No. 2022/0033998 (esp. FIGS. 10A-10M), the reference incorporated by reference in its entirety herein.

The first advantage of this dual material elastomer filament is handling during printing. The rigid core dramatically increases the force necessary to cause filament buckling during longitudinal compression. As a result, the filament can be consistently advanced into and through the print head during printing. Soft materials, such as 75A elastomers, that cannot be easily printed as a single material filament can be easily printed when combined with a rigid filament core.

The second advantage of this dual material elastomer filament is print quality. The rigid core quickly cools to below the flow temperature of the core material, so that as the print head stops extrusion and moves to a new print location, the extrudate melt breaks cleanly at the print nozzle without the stringing and slumping that is common when printing with filaments made wholly of elastomeric polymer.

A third advantage of this dual material elastomer filament is that the resulting printed solid has directionally sensitive mechanical properties, also known as anisotropic mechanical properties. Specifically, the printed structure will be stiffer when loaded along the trace direction, where the rigid core material is loaded directly. The printed structure will be less stiff when loaded in a direction perpendicular to the trace direction, where the elastomer phase can freely stretch even if the rigid material is not stretching. Said differently, along the traces the rigid and elastomer phases are loaded in parallel, and will obey rule-of-mixtures for elastic modulus; perpendicular to the traces, the rigid and elastomer phases are loaded in series, and will obey the inverse rule-of-mixtures for elastic modulus. For example, the stiffness of the part along the trace direction, compared to perpendicular to the trace direction, can be 2×, 5×, 10×, 20×, 50×, 100×, 200×, 500× or even 1000× higher. The ratio of directional stiffnesses will depend on multiple factors, principally: the proportion of the cross-sectional areas of the elastomer and rigid polymer in the cross-section of the filament; and the stiffness values of the rigid and elastomer phases. For example, consider a dual material filament comprising an elastomer sheath component with a modulus of 25 MPa and a rigid polymer core component with a modulus of 2500 MPa. If the filament cross-sectional area is 90% rigid polymer and 10% elastomer, the resulting ratio of longitudinal to perpendicular stiffnesses in a uniaxial printed part would be expected to be around 10×. If instead the filament cross-sectional area is 50% rigid polymer and 50% elastomer, the resulting ratio of longitudinal to perpendicular stiffnesses would be expected to be around 25×. If the elastomer modulus is reduced to 5 MPa, then the modulus ratio for a uniaxial part printed from a 50% rigid and 50% elastomer filament would be 125×.

Since the trace direction is programmed deterministically and controlled via a computer interface, it is therefore possible to use this filament to build solids that have tuned directional stiffness. Different areas and volumes of the part can be stiff or compliant in any direction, just based on the path taken during printing. This feature allows for the printing of hinges, folding structures, and nonlinear mechanics that are otherwise not possible with conventional single material filaments.

The descriptions provided here (and for other examples and embodiments) are not meant to be limiting. For example, we envision three or more materials combined into a single filament, where the multiple materials can include at least one elastomer but may include multiple elastomers. We also envision cases where multiple elastomers are combined into a single filament, for example a two-material filament comprising one softer elastomer and one harder elastomer.

### Elastomers for Cold Weather Durability

In another form of the invention, elastomers are combined with rigid polymers to form printed solids with cold weather durability.

In one embodiment, the filaments are consistent with the features described above: one elastomer phase, one rigid phase; where the outer surface of the filament is mostly comprised of the elastomer phase.

Because elastomers generally maintain their toughness and resilience to lower temperatures than rigid polymers, the combination of elastomer with rigid polymer can result in a printed structure that has cold weather durability as well as stiffness. For example, if the structure consists of a rigid core that comprises 75% or more of the filament cross section, while the sheath is composed of the elastomer phase, then the resulting printed structure would have a continuous elastomeric phase. This continuous elastomeric phase would be tough under cold conditions, and could arrest brittle cracks that form in the rigid phase such as under cold loading conditions. The rigid phase would still provide overall stiffness to the solid so that it could serve a structural function. The print pathing would be designed to maximize the part stiffness along directions that are most critical for high stiffness. The rigid phase in other exemplars might be 50%, 80%, 85%, 90%, or 95% of the filament cross-sectional area.

The combination of stiffness and cold weather toughness made available by this dual material filament, and the resulting printed solids, would be vastly superior to those of single-material composition. A solid comprised of only the rigid polymer would become brittle at low temperatures; whereas a solid comprised of only the elastomer would be too deformable to be used for structural applications.

### Other Cold Weather Durable Filaments

Some thermoplastics are unusually durable under cold conditions. One notable example is blends of PC and PBT (which we will refer to as PC-PBT), sold under the tradename Xenoy (Sabic). These materials are rigid at room temperature, but maintain a remarkable level of toughness under cold conditions. The materials can be filamentized and printed into 3D solids. Unfortunately, the strength and toughness of these printed solids, between layers, is very poor due to insufficient wetting and bonding between layers.

In another form of the invention, PC-PBT is combined with elastomer to form a dual material filament for 3D printing. In one embodiment, the filaments are consistent with the features described above: one elastomer phase, one rigid phase; where the outer surface of the filament is mostly comprised of the elastomer phase. For this embodiment, the rigid phase is PC-PBT.

Solids printed from this filament would have a number of useful features. First, depending on the volume fraction of PC-PBT used, the printed solids with have good structural stiffness. The dual material filament could be used for 3D printed objects where the toughness at cold conditions (e.g., <0° C.) is not less than 50% lower than the toughness at 25° C.; or, if the toughness is considerably higher than other common engineering thermoplastics. The objects could also be printed to have a minimum stiffness value (e.g., a tensile modulus of at least 0.5 GPa). Volume fractions of PC-PBT could be 50%, 60%, 75%, 85%, 90%, 95%, or higher, or any intermediate composition. During printing the elastomeric sheath would form a strong bond between traces and layers, overcoming the weak inter-layer bonding observed for conventional PC-PBT printed solids. The PC-PBT core would also stabilize the printed solid curing post-print annealing to further increase part strength and toughness. In addition, the printed solid would have high resilience in cold conditions; both the elastomer phase and PC-PBT phase would be durable to low temperatures.

In another embodiment, PC-PBT is used in a dual material filament that does not include elastomer. In one embodiment, PC-PBT forms a core of a dual material filament, with some or all of the features as already described above; however, the second material that comprises most of the outer surface of the filament would not be an elastomer. Instead, this second material would be another rigid polymer with a flow temperature lower than that of PC-PBT; for example, the second polymer could be ABS, PETG, or ASA. In this example, the part would be printed and then annealed to build a strong bond between traces and layers, with the PC-PBT core stabilizing the part during annealing. This part would have good toughness to cold conditions, high stiffness, and good strength and toughness between traces and layers.

In another embodiment, PC-PBT comprises most of the outer surface of a dual material filament, where the core of the filament is second polymer that is also rigid. The core polymer could be any of the wide range of structural thermoplastics that can be printed. Preferably, the core polymer has a higher flow temperature than PC-PBT. In this scenario, a printed solid can be annealed after printing to allow the PC-PBT to form high strength bonds between layers and traces. This part would have a continuous PC-PBT phase, so it would likely exhibit high stiffness and toughness even to low temperatures, even if loaded perpendicular to traces and layers. Polymers that are chemically similar to PC-PBT are likely to be good candidates for the core. Examples include polycarbonate; PET; PBT; and PC copolymers such as bisphenol TMC (BPTMC or 1,1-bis(4-hydroxyphenyl)-3,3,5-trimethylcyclohexane) and bisphenol-A (BPA) copolymer such as polymers known as APEC from Covestro. Particularly suitable grades of APEC include 1695, 1795, 1895, and 2095. PC and APEC polymers would be likely to form strong interfaces with the PC-PBT phase, and would stabilize the printed solid during annealing of PC-PBT.

### 1. Experimental Results

### 1.1. Materials

The rigid polymer used in this study was Cycolac™ MG94 ABS from SABIC Innovative Plastics (Riyadh, Saudi Arabia). For the TPE, TPSiV 4200-75A SR thermoplastic vulcanizate (TPV) (shore hardness—75A) from Dupont (Wilmington, DE) was used. This TPV will be referred to generically as a thermoplastic elastomer (TPE) within this experimental study. Before every extrusion trial, ABS was dried at 85° C. for 2-4 hours while the TPE was dried at 90° C. for 3-6 hours using desiccant dryers.

### 1.2. Rheology

The low shear strain viscosities of the polymers were characterized using a parallel plate rheometer ARES G2 (TA instruments, New Castle, DE). Parallel plate rheology was carried out over a temperature range of 220° C. to 250° C. for TPE, and 210° C. to 240° C. for ABS. Parallel plates having a diameter of 25 mm were used to perform all the tests. Amplitude sweep and frequency sweep were carried out to determine the linear viscosity regions (LVR). For high strain rate viscometry, an LCR 7000 (Dynisco, Franklin, MA) capillary rheometer was operated over the same temperature ranges used for shear rheology. The diameter of the barrel was 9.55 mm, whereas geometry of the capillary die (L/D=30, die exit diameter=0.762 mm) was used to analyze the pressure driven rheological characterizations. After charging the sample pellets into the barrel, each trial was given a soak time of 360 s before starting the measurements. The capillary rheology trials were operated in the shear rate zones of 300 s⁻¹ to 7000 s⁻¹. The capillary rheology data was extrapolated to low shear rates of 100 s⁻¹.

### 1.3. Filament Production and Quality

Filament production was carried out using Fiber Extrusion Technology (FET) equipment (Fiber Extrusion Technology Limited, Leeds, UK). The FET assembly has two separate single screw extruders (L/D=30), where extruder 1 has a screw diameter of 25 mm and extruder 2 has a screw diameter of 20 mm. The temperature profile for the co-extrusion process is described in Table 2. Extruders were calibrated with ABS and TPE at melt pump speeds of 2 rpm to 20 rpm, respectively, to generate extruder output calibration curves. The resulting extruder flow rate calibration curves were used to achieve the desired volume fractions of core-shell material in the filament. A water bath was used to accelerate the solidification of extrudate from the FET. At the end of water bath, air pressure was used to remove excess water from the surface of the filament. A Metralight (Burlingame, CA) XY laser micrometer was used to measure the eccentricity and diameter of the filaments. A Filabot (Barre, VT) spooler was used at the end of laser micrometer to collect the extruded filaments. The spooler maintained tension in the filament production line, which imparted a small amount of drawdown on the extrudate and minimized deviations in filament diameter. The filaments were dried and stored in a desiccant container.

TABLE 2
Temperature profiles for extrusion

| | Zone 1 | Zone 2 | Zone 3 | Zone 4 | Zone 5 | Zone 6 | Die |
|---|---|---|---|---|---|---|---|
| Extruder | (° C.) | (° C.) | (° C.) | (° C.) | (° C.) | (° C.) | (° C.) |
| TPE TPSiV 75A | 165 | 200 | 210 | 215 | 220 | 220 | 240 |
| (Shell) | | | | | | | |
| ABS MG94 | 165 | 210 | 230 | 240 | 240 | 240 | 240 |
| (core) | | | | | | | |

### 1.4. Specimen Preparation

For all specimens, print speed was 40 mm/s, bed temperature was 75° C., nozzle diameter was 0.4 mm, and layer height was 0.2 mm. The nozzle temperature was 240° C. for ABS, and 210° C. for ABS+TPE. Attempts to print TPE monofilaments, i.e., without an ABS core, were unsuccessful under all conditions due to buckling, stringing of filaments, and inconsistent part deposition.

Specimens were evaluated under two infill density conditions: low and high. Low infill samples assumed a filament diameter of 1.75 mm and implemented an extrusion multiplier of 1, for all filament combinations as implemented in the slicer (PrusaSlicer, version 2.6.0, Prusa Research, Czech Republic). The resulting samples had effective densities of 80%-89% for printed cubic specimens. For the high infill samples, first the slicer settings were tuned for each filament to achieve ≥95% infill density. For these specimens, diameter settings in the slicer were determined from laser micrometer measurements for each filament. Filament density was calculated based on the area fraction of ABS for each filament, from optical microscopy, and assumed manufacturer density values of 1.05 and 1.17 g/cm³ for ABS and TPE phases, respectively. Sample cubes of 20 mm per side were printed under various extrusion multiplier settings, then weighed and dimensioned to calculate a printed infill density value; the ratio of printed density to filament density is the infill density. Extrusion multiplier values were adjusted until the infill density achieved 95% or higher for each filament, and then these settings were used to print the high infill specimens.

The 3-point bend specimens were printed parallel to the bed with an infill pattern of all perimeters, to create effectively uniaxial test specimens. The dimensions of the flexural specimens were 65 mm×12.7 mm×3.2 mm per ASTM D790-17. The Izod impact specimens were vertically printed at 12.7 mm×12.7 mm×63.5 mm per ASTM D256-10, with 4 perimeters and a rectilinear 0-90 infill. The tensile testing specimens were manufactured according to Type 1 of ASTM D638, with a cross-sectional area of 7 mm×13 mm. The length of the narrow section was 57 mm, with an overall sample length 165 mm. The infill pattern for the tensile bars was identical to the Izod specimens; it was also printed in the vertical direction so that tensile loading is perpendicular to the interlayer print interfaces. Since TPE monofilament is not printable due to significant buckling, bulk properties of TPE are measured using compression molded specimens. Molding was performed at upper and lower platen temperatures of 210° C. and a clamp pressure of 8.16 MPa. Specimens had a narrow section width of 6.2±0.1 mm, thickness of 2.5±0.2 mm, narrow section length of 60 mm, and overall sample length of 100 mm.

### 1.5. Mechanical Testing

### 1.5.1. Hardness Testing

The shore A hardness of printed specimens was measured using Shore A durometer (Fred V. Flower Company Inc, Newton, MA) as per ASTM D2240. Printed Izod testing specimens (12.7 mm×12.7 mm×63.5 mm) were used to perform the hardness testing. The durometer tip was calibrated using the predefined calibration hardness samples. Hardness value was recorded at 5 different locations along the specimen to validate uniformity of shore A hardness.

### 1.5.2. 3-Point Bending Testing

The 3-point bending test was carried out using ASTM D790-17 using an Instron 34SC-2 load frame (Instron, Norwood, MA) with a 2 kN load cell. The span length between the fixed rods was adjusted to 51.2 mm based on the specimen length-to-depth ratio of 16:1. Three specimens were tested for each material condition, with each specimen individually measured for subsequent calculations. The displacement rate was adjusted to 5 mm/min since most specimens were very flexible up to flexural strain levels of 15%. The results were then analyzed to calculate and report Young's modulus (MPa). The Young's modulus of printed specimens is very low, so they do not exhibit a valid failure. After 20% strain the sample slips from the 3-point bending fixture without a failure or crack propagation in the specimen.

### 1.5.3. Izod Testing

Izod impact testing of printed specimens was carried out on a Tinius Olsen (Horsham, PA) model IT503 low energy impact tester using ASTM D256-10. Five specimens were tested for each core-shell ratio combination. The width and depth of all specimens was recorded, followed by notching of the test specimens. The samples were mounted on TMI notching cutter (Model: TMI 2205, Manufactured by Testing Machines Inc, Amityville, New York) with feed speed of 200 mm/min and cutter speed of 1000 rpm. Notched depth of the specimens was evaluated to ensure consistency. The impact hammer was weighted to reach a mass force of 33.7 N, resulting in a pendulum energy of 15.03 J. The impact testing pendulum was calibrated to eliminate friction losses due to air resistance in the system.

### 1.5.4. Tensile Testing

Tensile testing was performed according to ASTM D638 using an Instron (Norwood, MA) model 5966 load frame with a 10 kN load cell and a displacement rate of 5 mm/min. The gauge length between the grips was adjusted to 100 mm. The thickness and width of all print specimens was measured prior to testing. Five tensile bar specimens were tested for each core-shell filament combination. All tensile bars printed in the results section are printed in the vertical z-direction; those printed in flatbed XYZ orientations and the resulting tensile data are displayed in supporting information in Table 3.

TABLE 3
Mechanical performance of tensile bars in XYZ direction (flat
printed samples, ASTM D638- type 1, thickness = 3.2 mm,
printing raster angle = unidirectional 0° and 90° respectively).

| | | | | Strain at |
|---|---|---|---|---|
| % of | Layer Orientation | Modulus | Tensile Strength | Break |
| ABS | (degrees) | (MPa) | (MPa) | (%) |
| 100 | 0° | 2049.21 | 35.91 | 2.23 |
| 100 | 90° | 1951.95 | 29.91 | 2.3 |
| 75 | 0° | 1327.93 | 29.02 | 17.36 |
| 75 | 90° | 252.48 | 7.68 | 14.57 |
| 50 | 0° | 976.84 | 20.63 | 60.81 |
| 50 | 90° | 108.34 | 6.09 | 31.13 |
| 30 | 0° | 677.63 | 13.91 | 83.23 |
| 30 | 90° | 55.68 | 6.9 | 84.98 |

### 1.6. Optical and Atomic Force Microscopy (AFM)

Small sections of filaments were mounted in epoxy and sliced using a precision saw to obtain a smooth surface for AFM and microscopy. Optical microscope images were recorded using a Zeiss (Oberkochen, Germany) Discovery V20 stereo microscope.

The interfacial features were assessed by AFM-modulus mapping for both the feedstock filaments and additive manufactured parts. The AFM instrument used was Bruker (Billerica, MA) multimode 8 with a Digital Instruments/Bruker Nanoscope®V controller with data collection using Nanoscope version 8.15 software in PeakForce QNM mode. Probes used for imaging were Budget Sensors Tap150Al-G (supplied by Ted Pella, Redding, CA) having nominal force constant 5 N/m and resonant frequency of 150 kHz. The force constant was measured via the thermal tune method for five probes, ranging from 3.3-4.9 N/m with deflection sensitivities ranging from 41.1-46.0 nm/V. Typical scan sizes selected were 5 and 20 μm to show the fine microstructure of each material as well as the interface between them. Scan rates were typically less than 1 Hz to accommodate the PeakForce QNM algorithm which collected fast force curves at a rate of approximately 2 kHz and applies the DMT contact mechanics model with an initial assumed contact radius of 10 nm to calculate “DMT modulus” for each pixel. Images were further analyzed using Gwiddion version 2.60 SPM data visualization and analysis tool. Normalization of the compressional modulus pixels was done by making two assumptions: (1) the rigid phase in the ABS chemical composition is nearly 100% polystyrene, and (2) the “compressional” modulus of these polystyrene islands is 2.7 GPa, an average literature value for polystyrene modulus of elasticity. All other microstructural components were shifted with respect to these assumptions. By using this normalization method, the contact radius assumed in the DMT modulus model was no longer 10 nm, however it became possible to compare and differentiate modulus values for various images as well as tips used.

### 1.7. Application Demonstration

The ABS+TPE filaments can be used to build parts with complex geometry and behavior that cannot be achieved using filaments of only ABS or TPE. For this work, a coil spring geometry was selected to demonstrate a unique mechanical response. ABS and ABS+TPE (50 vol % ABS) filaments were used for printing the demonstration items. The elastic spring constant k for a coil spring is given by Equation (1) below,

$$k = \frac{G \cdot {d}^{4}}{8 \cdot n \cdot {D}^{3}} \approx \frac{E \cdot {d}^{4}}{16 ( 1 + μ ) \cdot n \cdot {D}^{3}} \approx \frac{E \cdot {d}^{4}}{20.8 \cdot n \cdot {D}^{3}} \qquad [ 1 ]$$

where G is the elastic shear modulus, E is the elastic tensile modulus, m is Poisson's ratio, d is wire diameter, D is coil diameter, and n is the number of coils. By assuming isotropic material properties and a Poisson's ratio of 0.3, springs were designed for both ABS and ABS+TPE to achieve similar spring constants. The resulting parameters were as follows: the ABS spring has D=15 mm, d=2 mm, n=6, and, assuming an E=2.5 GPa, results in k=95 N/m. The ABS+TPE (50% ABS+50% TPE) dual material spring has D=12 mm, d=2.8 mm, and n=6, whereas ABS+TPE (32% ABS+68% TPE) dual material spring has D=12 mm, d=3 mm, and n=6. The filament direction elastic modulus of the ABS+TPE is estimated to be 1.25 GPa, while the transverse elastic modulus is estimated to be 8.4 MPa. Using these two modulus values (100% ABS and 50% ABS+50% TPE) with the spring model, gives spring constant estimates of 2.4 N/m and 357 N/m. Due to the anisotropic nature of the ABS+TPE material, we would expect a spring response intermediate between these two values.

Spring coils were printed in the z-direction using a support material for dimensional stability. Print parameters were tuned to achieve 95% fill density. After print completion, the support material was removed to obtain the final printed coil spring specimens for tensile testing. The printed springs were subjected to mechanical load frame testing with a 2 kN load cell and a displacement rate of 5 mm/min.

### 2. Results

### 2.1. Melt Rheology

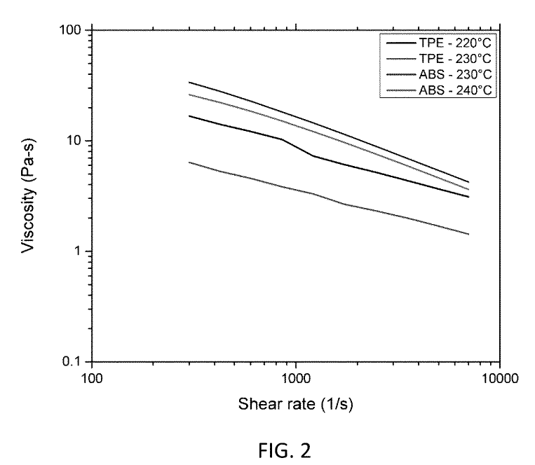

FIG. 2 shows viscosity data for ABS and TPE at 220-240° C. from the high shear rate (capillary) rheology experiments. The materials exhibit similar viscosity magnitudes at temperatures of 220° C. for TPE and 240° C. for ABS.

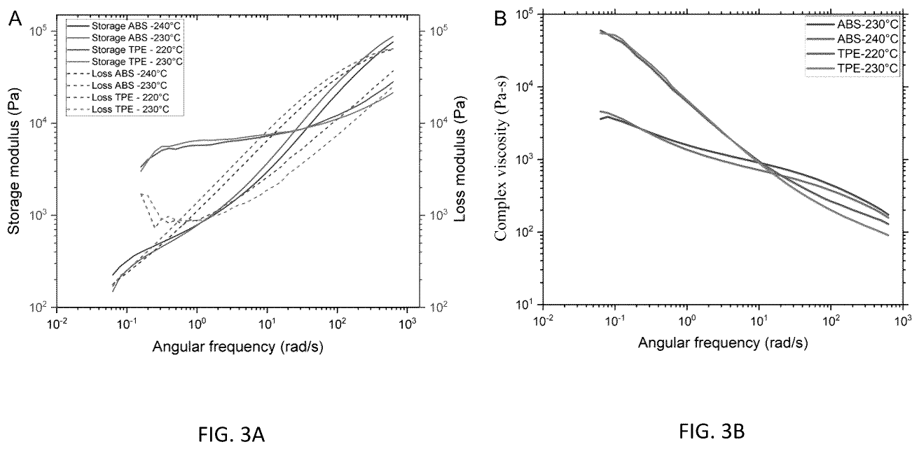

FIGS. 3A and 3B show the storage modulus, loss modulus, and complex viscosity of ABS and TPE, as measured via low shear oscillatory viscometry. This data was used to calculate relaxation times for each material using equation (2):

$$t = {η}_{0} / K \qquad [ 2 ]$$

where t is relaxation time of polymer chains, no is the zero-shear viscosity of the polymer at a given temperature, and K is the storage modulus at cross-over of storage modulus and loss modulus. The zero-shear viscosity was calculated using the Cross model for polymer melt viscosity dependence on shear rate. As shown in Table 4, the relaxation times at 220° C. for TPE and 240° C. for ABS are similar, around 7 s. This temperature range is in good agreement with viscosity measurements from FIG. 1.

TABLE 4
Relaxation time based on Cross model and Equation (2)

| | Zero shear | | Relaxation |
|---|---|---|---|
| Sample - | Viscosity | Crossover modulus | Time |
| Temperature | (MPa-s) | (MPa) | (sec) |
| TPE-220° C. | 0.107 | 0.014 | 7.52 |
| TPE-230° C. | 0.074 | 0.016 | 4.49 |
| ABS-230° C. | 1.223 | 0.052 | 23.7 |
| ABS-240° C. | 0.497 | 0.065 | 7.65 |

The co-extrusion process is driven by stable melt flow and minimal viscosity mismatch to achieve uniformity in the resultant filaments. Moreover, if both the materials have similar relaxation times, it likely promotes better interfacial wetting between core and shell phases. Based on the present measurements, melt temperatures of 220° C. and 240° C. for TPE and ABS, respectively, were selected for filament co-extrusion.

### 2.2. Filament Quality and Printability

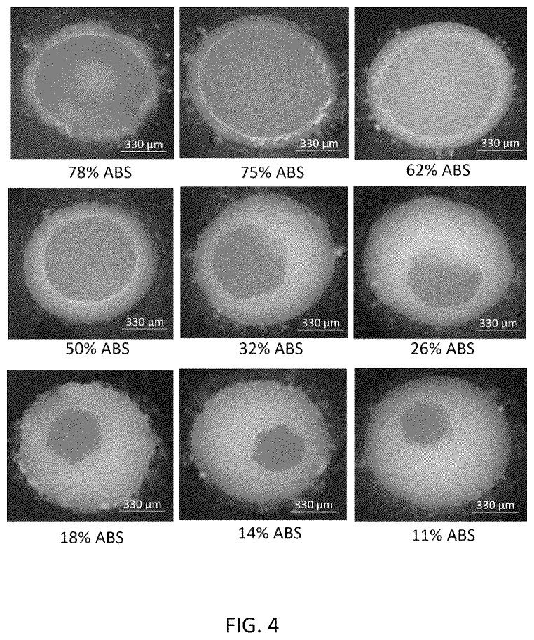

Extruder mass flow rate curves) were generated and used to select melt pump speeds for TPE and ABS extrusion to achieve a wide range of filament compositions. FIG. 4 shows cross-sectional images of produced filaments with various ABS+TPE core-shell ratio combinations. Imaging was used to evaluate the ABS area fraction of core-shell filaments (Table 5).

TABLE 5
Melt pump used for ABS and TPE and the corresponding area
percentage of the core and shell within the filament

| Melt Pump | Melt Pump | | | |
|---|---|---|---|---|
| speed - ABS | speed - TPE | Area of core | Area of shell | % of core |
| (RPM) | (RPM) | (mm²) | (mm²) | (ABS area %) |
| 10 | 6 | 1.57 | 0.43 | 78.6 |
| 16 | 12 | 1.56 | 0.53 | 74.6 |
| 12 | 12 | 1.44 | 0.88 | 62.2 |
| 6 | 12 | 1.12 | 1.22 | 49.5 |
| 4 | 18 | 0.77 | 1.63 | 31.9 |
| 3 | 18 | 0.63 | 1.84 | 25.6 |
| 2 | 18 | 0.43 | 1.87 | 18.5 |
| 1 | 12 | 0.35 | 2.17 | 14.0 |
| 1.5 | 22.5 | 0.26 | 2.15 | 10.8 |

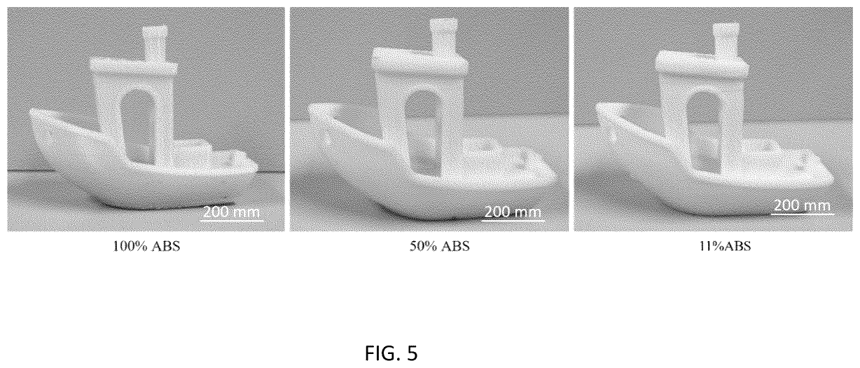

The representative filaments from each combination were used to showcase filament printability. As shown in FIG. 5, the 3D benchy geometry was printed using 100% ABS, 50% ABS, and 11% ABS filaments, respectively. In general, all print structures showcase smooth surface finish and good overhang print resolution. Critically, filaments made with 100% TPE (or “0% ABS”) were not printable, due to multiple factors including flex and tearing in the print head feed mechanism, and excessive stringing during printing. These results show that, even with only 11% ABS, the presence of the more rigid core provides a dramatic improvement in the printability of TPE filament.

### 2.3. Print Part Interface Analysis

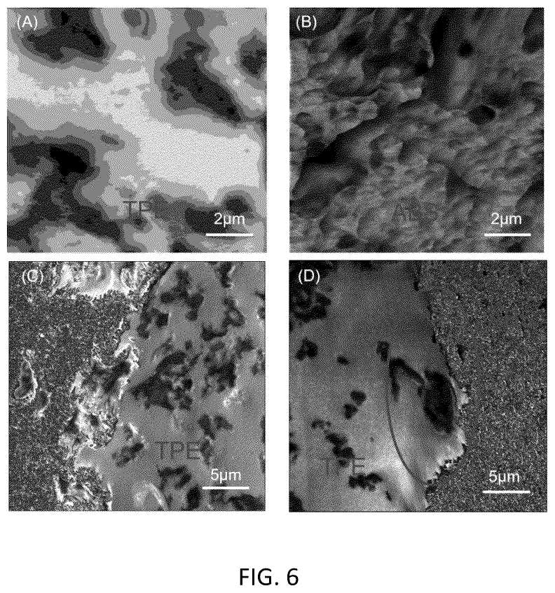

AFM modulus mapping displayed in FIG. 6 below highlights the contrast of high and low modulus sections within the filament and the print structures.

FIG. 6A displays the modulus mapping for TPE alone, consisting of a high distribution of low modulus elastomeric material and small areas of high modulus thermoplastic phase present in the TPE material. ABS MG94, on the other hand, is a uniformly distributed terpolymers formed by blending of thermoplastic copolymer of acrylonitrile and styrene (SAN matrix) with elastomeric phase of butadiene. FIG. 6B highlights ABS microstructure, consisting of high modulus, glassy regions due to acrylonitrile and styrene, with a small section of rubbery butadiene. FIG. 6C highlights the high and low modulus regions based on the core-shell structures of the filament.

Overall, the high modulus (i.e., darker black color) sections are represented by ABS, whereas low modulus (i.e., lighter grey color) sections are due to the TPE. The interface between ABS and TPE in core-shell geometry is sharp, lacking obvious migration of ABS or TPE components along the interface to form a zone of mixed composition; this is consistent in both filament (FIG. 6C) and print structure (FIG. 6D). Interfacial separation between the ABS and TPE regions is not visible, suggesting reasonable compatibility and bonding between phases.

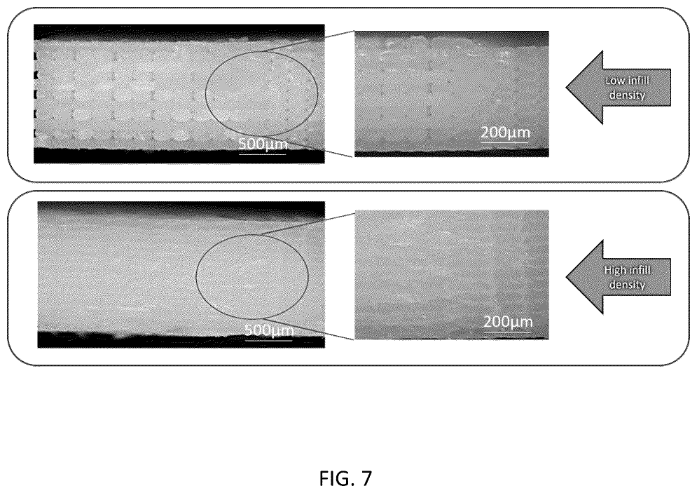

The cross-sectional optical images of print structures shows that the core-shell filament structure of ABS and TPE is successfully preserved in printed specimens, although at reduced size scale as the 1.75 mm-diameter filament is compacted to 0.2 mm extrudate (FIG. 7). Extrudate packing is efficient and consistent, resulting in compact print layers and well-ordered arrangement of the ABS and TPE phases. It is notable that the low infill density (85%) parts have more pronounced voids between the print roads than the high infill ones (95%); such morphological differences are expected to affect the mechanical properties of the parts, which are discussed in section 3.4.

### 2.4. Mechanical Performance

2.4.1. Shore A ardness

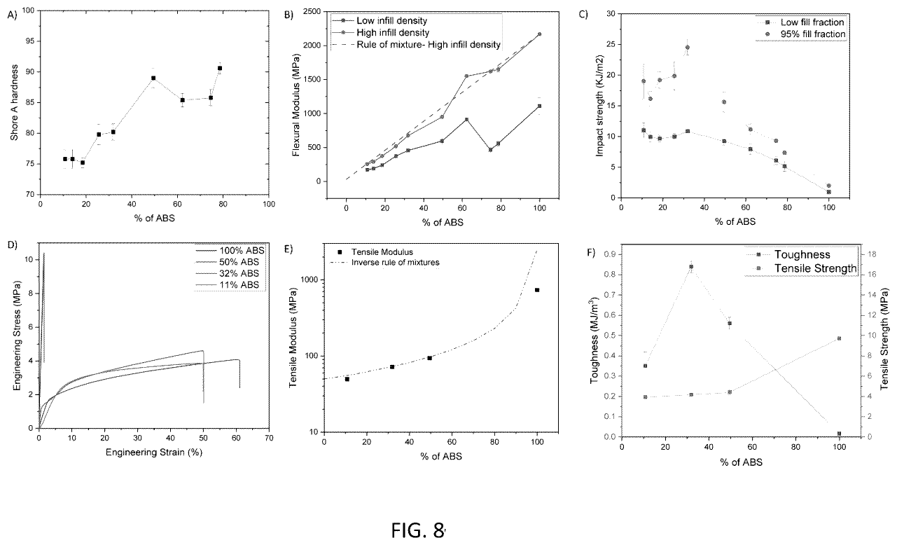

FIG. 8A shows the results of Shore A hardness testing over all ABS+TPE compositions. Hardness values are not reported for 100% ABS, as the material hardness is outside the applicable range of Shore A. Hardness gradually decreases as the ABS content decreases from 79% to 19% (consequently, as TPE content increases). Dual material samples with ABS content of 19%, 14%, and 11% all exhibit hardness values around 75A, identical to the rated hardness of the bulk TPE. These results suggest that shore hardness of printed specimens is marginally, if at all, affected by the presence of the hard ABS core, as long as the ABS volume fraction is sufficiently low (<20%).

### 2.4.2. 3-Point Bending

FIG. 8B shows the flexural modulus for printed structures as a function of ABS %, for both low and high infill prints. In general, the modulus tracks according to the TPE volume fraction. For the highly filled samples, bending modulus values show a consistent increase with ABS content, ranging from 0.3 to 2.2 GPa; given the respective volume % of TPE and ABS and the manufacturer reported modulus of 4.2 MPa at 100% strain (TPE) and 2.5 GPa (ABS), the composite modulus are consistent with a rule-of-mixtures model (blue dashed line in FIG. 8B). The bending data therefore suggests that, even at the lowest ABS content of 11%, the ABS phase is significantly contributing to bending resistance. Because the samples are effectively uniaxially oriented (all perimeter fill pattern), the ABS cores act like a reinforcement, and a rule-of-mixtures analysis effectively predicts flexural modulus. These materials therefore can be considered a printed composite material. For the low infill samples, modulus increases less sharply with ABS content, compared to the high infill samples, and shows a drop in flexural modulus for 75% and 79% ABS content. This drop in modulus is likely due to early sample delamination due to low interlayer contact and bonding, rather than the intrinsic material properties. Displacement at yield increases as the vol % of ABS decreases from 50% to 100%, resulting in increased flexibility of printed specimens.

### 2.4.3. Izod Impact Testing

FIG. 8C displays the Izod impact strength of z-direction printed specimens as a function of filament composition. It shows that the impact strength along z-direction increases by an order of magnitude as ABS content is reduced from 100% to 32%, and further it exhibits consistent impact strength of 20 KJ/m² up to 11% ABS. This result could be due to several factors. First, the volumetric elastic-plastic energy absorption for deformation of TPE is expected to be higher than that of more rigid thermoplastics such as ABS. Second, the soft low modulus TPE blunts crack tips and yields at low stresses. Finally, TPE may provide enhanced as-printed interlayer bonding due to its low T_{g} (−46° C.) relative to the print deposition temperature. It is also observed that the Izod impact strength approximately doubles when the infill density changes from low fill (80% to 85% based on core shell ratio) to 95% infill density. This enhancement is observed due to better surface contact between consecutive layers, leading to more interlaminar bonded area.

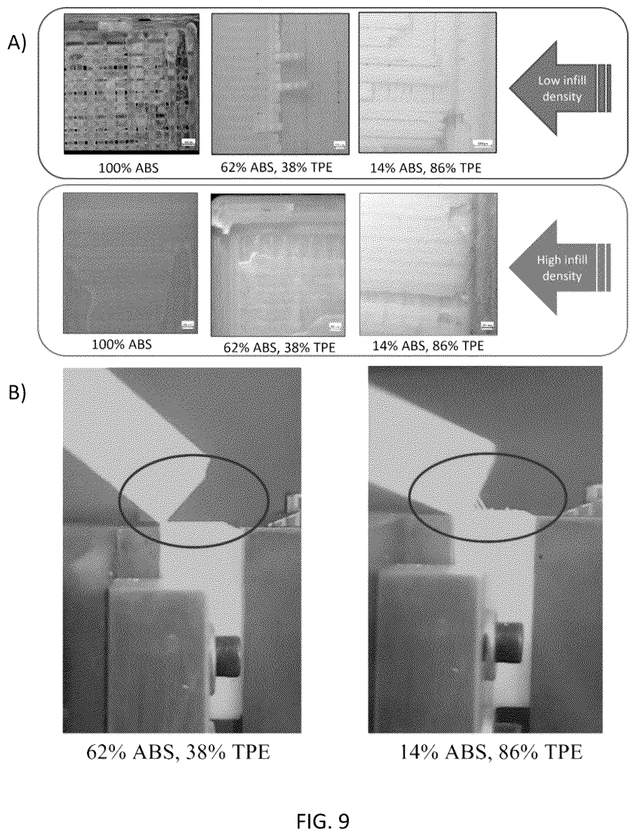

The Izod fracture surface pattern also changes with the core-shell ratio within the printed specimens. FIG. 9 displays that 100% ABS undergoes a brittle failure with a sharp yielding point, where failure is primarily propagated along a single print layer interface. Whereas at lower ABS % the failure type changes from brittle failure to ductile failure; the print layer undergoes more pronounced stress whitening before reaching the point of break. The extent of stress whitening is driven by core-shell ratio combination between ABS+TPE filaments, i.e., lower ABS % (or higher TPE %) results in more stress whitening. A higher ABS % (lower TPE %) results in failure of specimens within the one or two z-direction layers, whereas lower ABS % (higher TPE %) results in failure through multiple print layers (>3,4). Higher fill density within the print specimens increases the ability to absorb the impact energy significantly, affecting the failure behavior in the prints. It can be observed that an increase in infill density enhances the surface contact area between print layers in all the print directions (x, y, and z direction).

### 2.4.4. Tensile Testing

The z-direction tensile results of the ABS and ABS+TPE printed parts are tabulated in Table 6; FIG. 8D shows representative stress-strain curves for each sample. A decrease in ABS content from 100% to 10% yields a decrease of ultimate stress from 10 MPa to 4 MPa, and a decrease in elastic modulus from 0.70 GPa to 0.05 GPa. The strain at break, however, yields a maximum value of 62% for a 32% ABS in ABS+TPE, compared to 1% for 100% ABS. As a result, the toughness of the ABS+TPE is 20-40 times greater than that of the 100% ABS.

TABLE 6
Tensile properties of the printed tensile bars (high infill density,
z-direction loading), compression molded bulk TPE sample

| | Average | Average | | | Average |
|---|---|---|---|---|---|
| | ultimate | ultimate | | | strain at |
| % | Stress | strain | Modulus | Toughness | yield |
| ABS | (MPa) | (%) | (MPa) | (MJ/m³) | (%) |
| 100 | 9.71 ± 0.52 | 1.53 ± 0.16 | 735.3 ± 43.0 | 0.02 ± 0.01 | 1.53 ± 0.16 |
| 50 | 4.42 ± 0.25 | 46.99 ± 3.83 | 100.3 ± 5.37 | 0.56 ± 0.02 | 1.83 ± 0.13 |
| 32 | 4.17 ± 0.11 | 62.15 ± 1.99 | 70.97 ± 5.53 | 0.84 ± 0.03 | 3.65 ± 0.15 |
| 11 | 3.93 ± 0.10 | 45.46 ± 3.35 | 51.21 ± 4.58 | 0.35 ± 0.07 | 9.37 ± 1.01 |
| 0* | 12.12 ± 1.4* | 566.4 ± 45.3* | 4.22 ± 0.14 | 12.19 ± 1.03* | 54.26 ± 5.65* |
| | | | (at 100% | | |
| | | | strain)* | | |

*compression molded bulk TPE result

The modulus data is well modeled by an inverse rule of mixtures (FIG. 8E), assuming an ABS modulus of 2.5 GPa and a TPE modulus of 4.2 MPa at 100% strain, which would be the expected behavior since the ABS reinforcement phase is perpendicular to the loading direction. The strength values for ABS+TPE specimens, less than 5 MPa, is well below 12.12 MPa stress at break for compression-molded bulk TPE specimens (Table 6). This may be attributed to lack of interphase diffusion, and hence adhesion, between the TPE and ABS along the print road compared to compression molded specimens. FIG. 8F shows tensile toughness and strength as a function of ABS content. The data shows an optimal toughness at an ABS content of 32%. This optimal toughness is in good agreement with that of the Izod impact from FIG. 7C, which also has the highest toughness value at 32% ABS+68% TPE.

The tensile specimen fracture surface analysis shows that failure behavior in dual material prints is more ductile due to the presence of elastomeric core, similar to the Izod results. For 100% ABS prints, the failure propagates along a single layer along z-direction, whereas for dual material prints, the failure happens across multiple layers in z-direction. These differences suggest that the shell layer of dual material prints (ie. bonding between adjacent TPE layer) have better interlayer adhesion, likely due to the low softening temperature of the TPE allowing for more complete bondline wetting and entanglement.

### 2.5. Application Demonstration Model

FIG. 10 shows the tensile performance of coil springs for 100% ABS and 50% ABS (ABS+TPE) materials based on cyclic dynamic fatigue testing. ABS+TPE springs exhibit higher z-direction tensile breaking load compared to that of ABS springs, presumably owing to better interlayer bonding and greater flexibility. The 100% ABS spring starts to undergo permanent deformation and layer separation at an extension of 60 mm (FIG. 9D), whereas coil springs made up of ABS+TPE core shell dual material filament exhibits good extensibility up to 120 mm extension. After completion of cyclic loading for the ABS spring up to 120 mm extension, it records 108% permanent deformation (FIG. 9D). Hence, such high permanent deformation of ABS makes the spring unusable for the desired application. In contrast, the ABS+TPE spring has only ˜15% permanent deformation up to 120 mm extension. The ABS spring exhibits a spring constant of approximately 77 N/m, similar to model calculations. The ABS+TPE spring shows an initial spring constant of 16 N/m, transitioning to a higher spring constant of over 450 N/m at a displacement of 100 mm. Notably, this non-linear force-displacement response is highly reversible.

### 3. Discussion

### 3.1. Printability of ABS+TPE Filament

This study has shown that a rigid amorphous thermoplastic (ABS) and a soft thermoplastic (TPSiV TPE) can be successfully co-extruded into a high-quality filament feedstock for 3D printing. This filament can be used in a low-cost desktop FFF printer to consistently produce parts of z and surface quality, without specialized printer modifications, at ABS contents as low as 11%. The ease of printing with this material is remarkable, given that attempts to print using a filament comprising only the TPE without the ABS phase were not successful.

The ABS core likely contributes to print quality in several ways. First, the mechanical rigidity of the core increases loading required for buckling instability, making it possible for the filament feed mechanisms to provide consistent pressure on the hot end melt pool. Second, as the deposited melt quickly cools after deposition, the higher T_{g} of the core (˜100° C. for ABS) results in a stable elastic structure sooner than would be experienced for the TPE phase with its very low T_{g} (−46° C. for TPSiV). This mechanical stability during printing likely reduces stringing and smearing and creates a more stable substrate for subsequent print layers.

3.2. Mechanics of Parts Printed from ABS+TPE

The results show that stiffness and hardness of printed parts can be tuned systematically by varying the ratio of ABS to TPE. Because of the extreme difference in elastic modulus between the ABS and TPE components, characterized dual material printed solids showed over a 10× range in elastic modulus as the ABS content was varied. Hardness varied from 75A to 95A for TPE-containing filaments, with parts produced with 20% or less ABS exhibiting hardness nearly identical to the bulk hardness of the TPE alone. This result shows that a rigid core can be incorporated into the filament to enhance printability, without appreciably increasing the resulting softness of the manufactured part.

Elastic modulus of printed ABS+TPE solids closely followed linear rule-of-mixtures along the trace direction, and inverse rule-of-mixtures perpendicular to the trace direction. This behavior suggests that ABS+TPE solids should obey linear elastic, directionally-sensitive behaviors exhibited by oriented lamina and stacked laminates of varying orientation. Said differently, it should be possible to design layer-by-layer print orientation sequences to build multi-layer laminated solids with tailored or complex anisotropic behaviors.

Failure surfaces bridge across multiple print layers for ABS+TPE parts loaded in the z-direction, compared to the single-layer failure observed for fully ABS parts. This larger failure volume translates to higher impact strength and toughness, but with an unexpectedly low tensile failure strength; measured tensile strengths of 4 MPa are well below manufacturer specifications of 24 MPa. AFM imaging shows that the ABS-to-TPE interface is continuous and in intimate contact, while failure surface microscopy shows no evidence of separation between ABS and TPE phases. Therefore, the low strength of the ABS+TPE tensile specimens does not seem to be limited by adhesion between phases. Perhaps the rigid ABS phase induces strain concentrations in the TPE matrix that leads to premature tearing and failure. Low fill density resulted in systematically poorer mechanical response, so that further tuning of fill fraction, or higher print temperatures, could increase TPE wetting and might enhance part strength.

In spite of this limitation, the results show that combinations of ABS and TPE provide higher toughness and impact strength than either ABS or TPE alone. For example, maximum tensile toughness (z-direction) and impact strength were observed at an ABS content of around 40%. Specimens with 78% ABS exhibited over 3.5× higher impact strength compared to a fully ABS specimen, but with only 25% lower stiffness. Further improvements in TPE strength should lead to even more dramatic gains in composite toughness.

The printed spring shows that practical objects can be produced with ABS+TPE filaments. The high reversibility and strain-to-failure for this spring could not be matched with a conventional rigid material. Interestingly, the ABS+TPE spring exhibited a reversible non-linear behavior, likely due to the response of the spring being dominated by the TPE phase at low strains, and by the ABS phase at high strains. This non-linear behavior is likely a consequence of the high anisotropy of the filament.

### 4. Conclusion

The fabrication and printing of core-shell ABS+TPE filaments via FFF are demonstrated. The dual material filament showcases great printability with notable mechanical responses, overcoming the critical complications of soft material FFF, e.g., low print resolution, repeatability, and buckling of filament. The dual material filaments can be fed into a conventional printer because they have a stiff core; most elastomer filaments are too soft and buckle if fed into a conventional printer. This allows the printed filament to have a soft component. Notably, the TPE monofilament is not printable while ABS+TPE dual material prints high resolution parts, even at ABS contents as low as 11%. ABS core provides mechanical stiffness to resist buckling during filament feed and imparts stability to print structure. Rheological characterizations elucidated the optimized extrusion parameters for filament production, extrudability through the print nozzle, and wetting characteristics at print interface using high and low shear viscometry. ABS and TPE at 240° C. and 220° C., respectively, yielded minimum viscosity mismatch and similar relaxation times, making the conditions suitable for both extrusion and printing.

ABS+TPE print structures (lower than 20% ABS) exhibit shore A hardness of 75A, comparable to the bulk softness. Flexural analysis shows that, for highly filled samples, bending modulus values show a consistent increase with ABS content, ranging from 0.3 GPa to 2.2 GPa. The mechanical performance analysis demonstrates that a decrease in ABS % from 100% to 32% increases z-direction impact strength from 2 kJ/m² to 24.5 kJ/m². Higher infill density enhances impact strength and bending modulus of print specimens due to improved surface contact area within successive layers. AFM modulus mapping highlights the presence of high and low modulus regions in the print structures, with a well-defined but intimate interface between the ABS and TPE. Altogether, ABS+TPE dual material extrusion additive manufacturing provides a novel pathway to achieve mechanical tunability and structural stability of printed thermoplastic structures based on interlayer cohesion as well as surface contact area.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A filament for use in 3D printing, the filament comprising a first thermoplastic polymer and a second thermoplastic polymer, the filament having an outer surface;
wherein the first thermoplastic polymer and the second thermoplastic polymer are physically associated in a geometric arrangement, in which a flow temperature of said first thermoplastic polymer is at least greater than 10 degrees Celsius higher than a flow temperature of said second thermoplastic polymer, and
wherein the filament has a diameter of at least one 1 millimeter, and
at least one of the polymers exhibits a glass transition temperature below 25° C. and has a hardness less than or equal to Shore 50D, and
the filament is used for 3D printing.

2. The filament of claim 1, where the second polymer has a glass transition temperature below 25° C. and has a hardness less than or equal to Shore 50D.

3. The filament of claim 2, where the second polymer has a hardness less than or equal to Shore 50D, and the first polymer has a hardness greater than or equal to Shore 70D.

4. The filament of claim 2, where the second polymer has a hardness less than or equal to Shore 75A, and the first polymer has a hardness greater than or equal to Shore 50D.

5. The filament of claim 2, where the second polymer has a hardness less than Shore 50D, and the first polymer has a hardness greater than Shore 55D.

6. The filament of claim 1, where the polymer that exhibits a glass transition temperature below 25° C. has an elastic modulus below 200 MPa.

7. The filament of claim 6, wherein the polymer that exhibits a glass transition temperature below 25° C. and has an elastic modulus below 200 MPa is the second polymer.

8. The filament of claim 7, where the elastic modulus of the first polymer is above 500 MPa.

9. The filament of claim 1, where at least 50% of the outer surface is comprised of the second thermoplastic polymer.

10. The filament of claim 1, where the first polymer has a recoverable elongation less than 50% and the second polymer has a recoverable elongation greater than 100%.

11. The filament of claim 1, wherein the first polymer is configured as a star-shaped core having a plurality of arms surrounded by the second polymer, wherein the arms do not reach the outside of the filament.

12. The filament of claim 1, where the second polymer is a thermoplastic elastomer, urethane, silicone, a thermoplastic rubber, or a thermoplastic urethane.

13. The filament of claim 12, where the thermoplastic elastomer is a styrenic block copolymer, thermoplastic polyolefinelastomer, thermoplastic vulcanizate, thermoplastic polyurethane, thermoplastic copolyester, thermoplastic polyamide, or unclassified thermoplastic elastomer.

14. The filament of claim 1, where the first polymer comprises is selected from the group consisting of: acrylonitrilebutadienestyrene (ABS); high density polyethylene (HDPE); low density polyethylene (LDPE); polyamide (PA); polyamide imide (PAI); polyarylate (PAR); polyaryletherketone (PAEK); polybutylene terephthalate (PBT); polycarbonate (PC); polyester; polyether sulfone (PES); polyetherketoneketone (PEKK); polyetheretherketone (PEEK); polyetherimide (PEI); polyetherketone (PEK); polyetherketonetherketoneketone (PEKEKK); polyethlyene (PE); polyethylene terephthalate (PET); polyimide (PI); polylactic acid (PLA); polymethyl methacrylate (PMMA); polyoxymethylene (POM); polyphenylene oxide (PPO); polyphenylene sulfide (PPS); polyphenylsulfone (PPSU); polyphthalamide (PPA); polyphthalate carbonate (PPC); polyproplyene (PP); polystyrene (PS); polysulfone (PSF); polyurethane (PU); polyvinyl chloride (PVC); polyvinylidene fluoride (PVDF); styrene acrylonitrile (SAN); styrene maleic anhydride (SMA); ultrahigh molecular weight polyethylene (UHMWPE); high impact polystyrene (HIPS); polyvinyl alcohol (PVA); glycol-modified polyethylene terephthalate (PETG); polytetrafluoroethylene (PTFE), acrylonitrile styrene acrylate (ASA), Nylon, and combinations thereof.

15. The filament of claim 1, where the first polymer is a PC copolymer of bisphenol TMC (BPTMC or 1,1-bis(4-hydroxyphenyl)-3,3,5-trimethylcyclohexane) and bisphenol-A (BPA).

16. A filament for use in 3D printing, the filament comprising a first thermoplastic polymer and a second thermoplastic polymer, the filament having an outer surface;
wherein the first thermoplastic polymer and the second thermoplastic polymer are physically associated in a geometric arrangement, in which a flow temperature of said first thermoplastic polymer is at least greater than 10 degrees Celsius higher than a flow temperature of said second thermoplastic polymer, and
wherein the filament has a diameter of at least one 1 millimeter,
the second polymer has a hardness less than or equal to Shore 50D, and the first polymer has a hardness greater than or equal to Shore 70D, and
the filament is used for 3D printing.

17. A filament for use in 3D printing, the filament comprising a first thermoplastic polymer and a second thermoplastic polymer, the filament having an outer surface;
wherein the filament has a diameter of at least one 1 millimeter, and
at least one of the polymers exhibits at least one glass transition temperature below 25° C., and
wherein the elastic modulus of only one of the polymers is below 200 MPa, and
the filament is used for 3D printing.

18. A process of feeding the filaments of claim 1 into a filament-fed 3D printer, and then using that printer to create a printed solid.

19. A printed solid that results from the process described in claim 18.

20. A process of claim 18, comprising thermal drawing, dual material extrusioning, and/or wire coating.

21. A process of thermally annealing the printed solid of claim 19, to improve or modify the structure or properties of the printed solid.

22. The printed solid of claim 19, where the elastic modulus of the printed solid when loaded in one direction is at least 5× higher than the elastic modulus of the solid when loaded along a perpendicular direction.
